(19) United States
(12) Patent Application Publication
(10) Pub. No.: US 2015/0206448 A1
(43) Pub. Date: Jul. 23, 2015

(54) ON-LINE EDUCATION SYSTEM WITH SYNCHRONOUS LECTURES

(71) Applicant: AlvaEDU, Inc., Boca Raton, FL (US)

(72) Inventor: Timothy D. Loudermilk, Delray Beach, FL (US)

(73) Assignee: AlvaEDU, Inc.

(21) Appl. No.: 14/599,572

(22) Filed: Jan. 19, 2015

Related U.S. Application Data
(60) Provisional application No. 61/930,290, filed on Jan. 22, 2014.

(51) Int. Cl. G09B 5/10; G09B 7/00; G06F 9/445; H04L 29/06; H04L 29/08; G06F 9/44; G09B 5/06; G06Q 50/20

(52) U.S. Cl. CPC G09B 5/10; G09B 5/065; G09B 7/00; G06Q 50/20; H04L 63/0861; H04L 67/22; G06F 8/30; G06F 8/60

(57) ABSTRACT

An on-line education or learning creation computer services system that creates college-level courses which can be downloaded to a student's tablet or wireless computer as an APP. Embodiments are specifically disclosed as an application builder routine that creates multiple protocol packages for college-level courses, and for a synchronous lecture routine that allows multiple students to engage in a virtual live lecture in real time from remote locations. Students may study courses on their computers while off-line, if desired. Professors may edit existing courses without taking them down from the servers or APP stores.

### CROSS-REFERENCE TO RELATED APPLICATIONS

The present application claims priority to provisional patent application Serial No. 61/930,290, titled “ON-LINE EDUCATION SYSTEM WITH SYNCHRONOUS LECTURES,” filed on Jan. 22, 2014.

### TECHNICAL FIELD

The technology disclosed herein relates generally to on-line education computer systems and is particularly directed to a learning creation computer services system of the type that creates college-level courses which can be downloaded to a student's tablet computer as an APP. Embodiments are specifically disclosed as an application builder routine that creates multiple protocol packages for college-level courses, and for a synchronous lecture routine that allows multiple students to engage in a virtual live lecture in real time from remote locations.

### STATEMENT REGARDING FEDERALLY SPONSORED RESEARCH OR DEVELOPMENT

None.

### BACKGROUND

On-line college courses have been available through private company service providers that post the on-line courses for the college. One typical example of such a private company service provider is a company known as “BlackBoard.” A professor of the college prepares the course content, but the college itself does not typically post the resulting course content on the Internet. Instead, the private company service provider does the posting. A company like BlackBoard provides other on-line services for college students, as well.

### SUMMARY

Accordingly, it is an advantage to provide a computer system that offers on-line learning courses in which a school's professor can build an application program that will be downloaded to registered students and will run as an APP on the student's tablet computer, allowing the student to take the course at the student's own pace.

It is another advantage to provide a computer system that offers on-line learning courses that download an APP to a student's tablet computer so that the student can study the course at the student's own pace, but also that monitor and track a student's progress, including when the student is off-line.

It is another advantage to provide a computer system that offers on-line learning courses that download an APP to a student's tablet computer, which uploads information about the student's studying progress as well as test answers back to the school computer, and includes validation of the student's identification without the student being aware of that function.

It is yet another advantage to provide a computer system that offers on-line learning courses that download an APP to a student tablet computer having a synchronous lecture capability that allows real-time interaction between a professor and a plurality of remote student users.

It is still another advantage to provide a computer system that offers on-line learning courses that are stored on LMS sites or “home” websites, in which the courses can be edited by a professor or trainer and, as part of the editing process, to re-structure the files as needed to make the editing process easier, and then when the course is to be re-published, to then re-purpose the course so that it is automatically uploaded to multiple different types of servers and APP stores; all this is done automatically and virtually simultaneously.

Additional advantages and other novel features will be set forth in part in the description that follows and in part will become apparent to those skilled in the art upon examination of the following or may be learned with the practice of the technology disclosed herein.

To achieve the foregoing and other advantages, and in accordance with one aspect, a computer system is provided, which comprises: (a) at least one professor computer having a first processing circuit, a first memory circuit, a first communication circuit, a first display, and a first input device; (b) at least one student computer having a second processing circuit, a second memory circuit, a second communication circuit, a second display, and a second input device; (c) a school computer having a third processing circuit, a third memory circuit, and a third communication circuit; and (d) at least one web server that is in communication, as needed, with the first communication circuit, the second communication circuit, and the third communication circuit; (e) wherein the first processing circuit and the third processing circuit, working together as needed, are programmed with computer code to perform functions of building an application (APP) by: (i) receiving content data and generating hypertext markup language (HTML) components; (ii) generating computer language code components; (iii) using the computer language code components and the HTML components, generating a package in at least one output protocol type, including at least one of: (A) a Java protocol package, and (B) an IOS protocol package; (iv) making the package available for downloading, by use of the at least one web server; and (f) wherein the second processing circuit is programmed with computer code to perform functions of: (i) downloading the package using the second communication circuit, and storing the package as an APP in the second memory circuit; and (ii) running the APP, as desired by a student, including the functions of: (A) displaying education course content on the second display, under control of the student, thereby allowing the student to study; and (B) tracking the student's studying progress when the student studies using the APP, whether the at least one student computer is currently on-line with the at least one web server or is currently off-line, and storing the studying progress in the second memory circuit.

In accordance with another aspect, a computer system is provided, which comprises: (a) at least one professor computer having a first processing circuit, a first memory circuit, a first communication circuit, a first display, and a first input device; (b) at least one student computer having a second processing circuit, a second memory circuit, a second communication circuit, a second display, and a second input device; (c) a school computer having a third processing circuit, a third memory circuit, and a third communication circuit; and (d) at least one web server that is in communication, as needed, with the first communication circuit, the second communication circuit, and the third communication circuit; (e) wherein the first processing circuit and the third processing circuit, working together as needed, are programmed with computer code to perform functions of building an application (APP) by: (i) receiving content data and generating hypertext markup language (HTML) components; (ii) generating computer language code components; (iii) using the computer language code components and the HTML components, generating a package in at least one output protocol type, including at least one of: (A) a Java protocol package, and (B) an IOS protocol package; (iv) making the package available for downloading, by use of the at least one web server; and (f) wherein the second processing circuit is programmed with computer code to perform functions of: (i) downloading the package using the second communication circuit, and storing the package as an APP in the second memory circuit; (ii) running the APP, as desired by a student, including the functions of: (A) displaying education course content on the second display, under control of the student, thereby allowing the student to study; (B) tracking the student's studying progress when the student studies using the APP, and storing the studying progress in the second memory circuit; and (C) communicating the studying progress to the school computer, under the control of the second processing circuit, using the second and third communication circuits when the student computer is on-line to the at least one web server.

In accordance with yet another aspect, a computer system is provided, which comprises: (a) at least one professor computer having a first processing circuit, a first memory circuit, a first communication circuit, a first display, and a first input device; (b) at least one student computer having a second processing circuit, a second memory circuit, a second communication circuit, a second display, and a second input device; (c) a school computer having a third processing circuit, a third memory circuit, and a third communication circuit; and (d) at least one web server that is in communication, as needed, with the first communication circuit, the second communication circuit, and the third communication circuit; (e) wherein the first processing circuit and the third processing circuit, working together as needed, are programmed with computer code to perform functions of building an application (APP) by: (i) receiving content data and generating hypertext markup language (HTML) components; (ii) generating computer language code components; (iii) using the computer language code components and the HTML components, generating a package in at least one output protocol type; (iv) making the package available for downloading, by use of the at least one web server; (f) wherein the first processing circuit is programmed with computer code to perform functions of: (i) allowing a professor to initiate a synchronous lecture, using the first communication circuit, the first display, and the first input device, as needed; (ii) broadcasting the synchronous lecture, using the at least one web server; (iii) displaying images of at least one student who is virtually attending the synchronous lecture from at least one remote location; (iv) during the synchronous lecture in real time, selecting a first student of the at least one student for answering a question posed by the professor, in near real time; (v) broadcasting an answer by the first student; and (g) wherein the second processing circuit is programmed with computer code to perform functions of: (i) downloading the package using the second communication circuit, and storing the package as an APP in the second memory circuit; (ii) running the APP as a synchronous lecture, at a predetermined time as determined by the third processing circuit: (iii) using the second display and the second communication circuit, allowing the at least one student to view the synchronous lecture in real time; and(iv) using the second input device and the second communication circuit, allowing the first student to respond in real time with the answer to the question posed by the professor.

In accordance with yet another aspect, a computer system is provided, which comprises: (a) a professor computer having a first processing circuit, a first memory circuit, a first communication circuit, a first display, and a first input device; (b) at least one student computer having a second processing circuit, a second memory circuit, a second communication circuit, a second display, and a second input device; (c) a school computer having a third processing circuit, a third memory circuit, and a third communication circuit; and (d) at least one web server that is in communication, as needed, with the first communication circuit, the second communication circuit, and the third communication circuit; (e) wherein the first processing circuit and the third processing circuit, working together as needed, are programmed with computer code to perform functions of modifying a first multi-media course by: (i) using at least one of the professor computer and the school computer, accessing the first multi-media course that is stored at a predetermined virtual location; (ii) using at least one of the professor computer and the school computer, viewing the first multi-media course as a plurality of individual files that can each be modified by native editing software; (iii) using at least one of the professor computer and the school computer, editing at least one of the plurality of individual files, thereby creating a second at least one individual file; (iv) storing the second at least one individual file at a predetermined virtual location that will be accessible by at least one of the professor computer and the school computer; (v) inserting the second at least one individual file into the first multi-media course, thereby integrating the second at least one individual file into a second multi-media course; (f) wherein the first processing circuit and the third processing circuit, working together as needed, are programmed with computer code to perform functions of re-purposing the second multi-media course automatically, by: (i) using at least one of the professor and school computers, uploading the second at least one individual file to at least one of the school computer and a home web server, thereby updating the first multi-media course into the second multi-media course at the at least one of the school computer and the home web server; (ii) using at least one of the professor and school computers, and using the second multi-media course, generating at least one of a Java package and an IOS package; (iii) using at least one of the professor computer, the school computer, and the home web server, uploading the at least one of the Java package and the IOS package to at least one corresponding APP store; and (g) wherein the second processing circuit is programmed with computer code to perform functions of allowing the at least one student computer, for use by at least one authorized student user, to access at least one of: (i) the second multi-media course at the school computer; (ii) the second multi-media course at the home web server; (iii) a new Android APP based on the Java package at an Android APP store; and (iv) a new Apple APP based on the IOS package at an Apple APP store.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a block diagram of the major components of a computer system that communicates with remote students, and presents on-line college-level course via distance learning, as constructed according to the principles of the technology disclosed herein.

FIG. 2 is a flow chart of the steps performed by an Application Builder Routine, used with the computer system of FIG. 1.

FIG. 3 is a flow chart of the initial steps performed by an APP Student User Routine, used with the computer system of FIG. 1.

FIG. 4 is a flow chart of the steps performed by an APP Student User Routine for advanced functions, used with the computer system of FIG. 1.

FIG. 5 is a flow chart of the steps performed by an Synchronous Lecture Routine, used with the computer system of FIG. 1.

FIG. 6 is a flow chart of the steps performed by routine executed on the school's computer system, as part of the computer system of FIG. 1.

FIG. 7 is a diagrammatic view of an example display showing a view on the computer display screen while the professor is speaking during a synchronous lecture.

FIG. 8 is a diagrammatic view of an example display showing a view on the computer display screen while a student is speaking during a synchronous lecture.

FIG. 9 is a flowchart of the steps performed by a routine for editing an existing course, using at least the school computer and the professor computer, as part of the computer system of FIG. 1.

FIG. 10 is a flowchart of the steps performed by a routine for re-structuring and re-purposing an existing course that had previously been stored on a school computer, an LMS site, or a “home” website, or perhaps using a separate computer from the computer system of FIG. 1, and potentially storing files in the cloud.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The terms “first” and “second” preceding an element name, e.g., first inlet, second inlet, etc., are used for identification purposes to distinguish between similar or related elements, results or concepts, and are not intended to necessarily imply order, nor are the terms “first” and “second” intended to preclude the inclusion of additional similar or related elements, results or concepts, unless otherwise indicated.

In addition, it should be understood that embodiments disclosed herein include both hardware and electronic components or modules that, for purposes of discussion, may be illustrated and described as if the majority of the components were implemented solely in hardware.

However, one of ordinary skill in the art, and based on a reading of this detailed description, would recognize that, in at least one embodiment, the electronic based aspects of the technology disclosed herein may be implemented in software. As such, it should be noted that a plurality of hardware and software-based devices, as well as a plurality of different structural components may be utilized to implement the technology disclosed herein.

It will be understood that the term “circuit” as used herein can represent an actual electronic circuit, such as an integrated circuit chip (or a portion thereof), or it can represent a function that is performed by a processing device, such as a microprocessor or an ASIC that includes a logic state machine or another form of processing element (including a sequential processing device). A specific type of circuit could be an analog circuit or a digital circuit of some type, although such a circuit possibly could be implemented in software by a logic state machine or a sequential processor. In other words, if a processing circuit is used to perform a desired function used in the technology disclosed herein (such as a demodulation function), then there might not be a specific “circuit” that could be called a “demodulation circuit;” however, there would be a demodulation “function” that is performed by the software. All of these possibilities are contemplated by the inventors, and are within the principles of the technology when discussing a “circuit.”

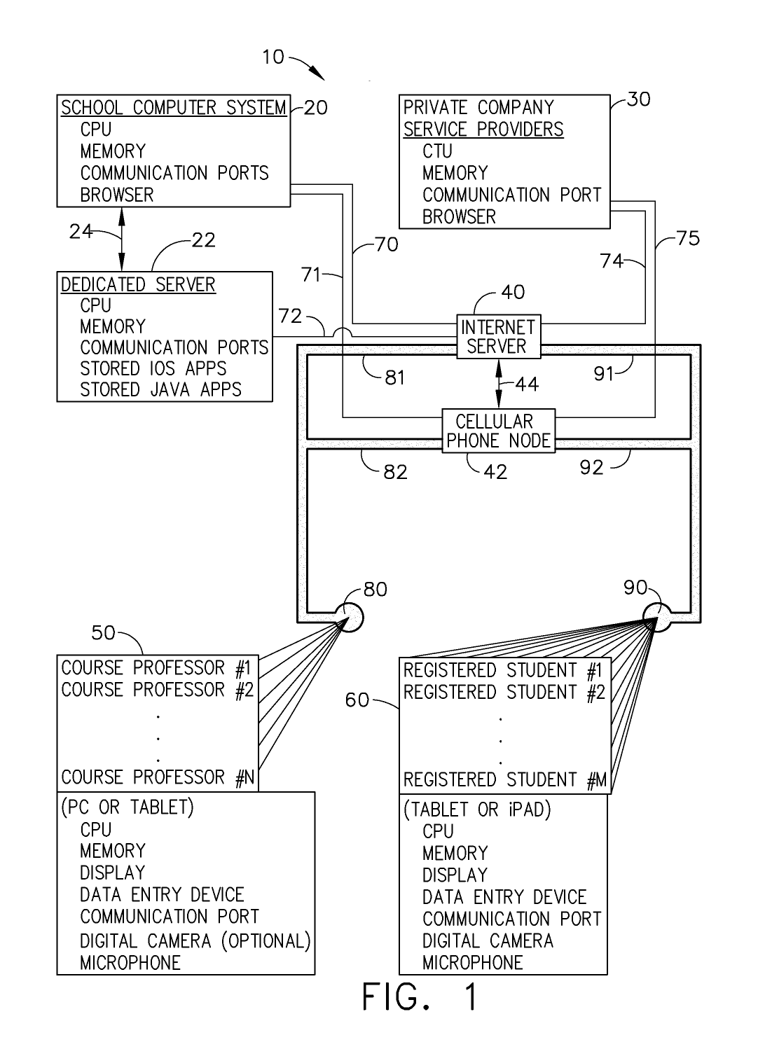

Referring now to FIG. 1, a computer system generally designated by the reference numeral 10 is depicted. In computer system 10, there is at least one school computer system at 20, and typically at least one private company service provider at 30. The school computer system 20 will typically have a dedicated server or router at 22 that is in communication with an Internet server 40. The private company service provider 30 also is in communication with the Internet server 40, either the same Internet server or a different Internet server of its own choosing, but is ultimately connected into the Internet as a whole.

The computer system 10 is generally designed to be used by persons having wireless portable computers. There is also a cellular phone node 42, and that cellular phone node is also in communication with the school computer system 20, the private company service provider 30, and the Internet server 40. The cellular phone node 42 is also in communication with a number of educators (called “professors” on FIG. 1) at 50, and a large number of students at 60.

It will be understood that the term “school” refers to colleges, universities, junior colleges, etc., and in general any type of education institute of higher learning. Conceivably the system 10 could also be used by high schools, but is generally designed for education institutes that teach at a higher level. It will also be understood that the private company service providers 30 can include several different types of companies, one typical example of which is a company called “BlackBoard,” which is a company that provides a web server that allows college students to register for their exact classes for a particular learning institution or “school.” There is more than one type of private company service provider, just like there is more than one type of school that can be connected into the computer system 10.

In general, the school computer system 20 includes some type of processing circuit, a memory circuit, communication ports, and some type of web browser software. By use of the communication ports, the school computer system 20 communicates to the dedicated server 22 via a communication link 24, and it communicates to the Internet server 40 and the cellular phone node 42 via communication links 70 and 71, respectively. The dedicated server 22 also includes a processing circuit, a memory circuit, communication ports, stored IOS (iPhone Operating System) applications, and stored Java applications.

The private company service provider 30 includes a processing circuit, a memory circuit, communication ports, and some type of web browser software. This system 30 communicates to the Internet server 40 and the cellular phone node 42 via links 74 and 75, respectively. The Internet server 40 and the cellular phone node 42 also communicate with one another, via a communication link 44. In general, all of these communication links discussed above are bidirectional links, although most of the commands or data being transferred through these communication links might be mainly in one direction. There is almost always some type of handshaking involved, and usually some type of security passwords or other types of scrutiny are involved in these communications.

At reference numeral 50, a number of “course professors” are depicted on FIG. 1. These are typically college professors, but can be other types of educators with other titles. In general, this patent document will refer to such personnel as a “professor,” but this includes all types of educators who interact with students. At reference numeral 60, there are a number of “registered students” depicted on FIG. 1. In general, these are persons who are exactly what is stated on FIG. 1, i.e., a registered student for one of these education institutions that are being referred to as “schools” herein. Typically, there would be a single course professor for a single college course, although there could be more than one such professor for a given course, including recitation professors and lab professors, or substitute professors, as needed or as designated by the school itself. In general, there would be a plurality of registered students for each college course, although it is conceivable that a particular course would have a single student. All of these possibilities are included in the system 10.

In the system 10, a professor would be using some type of computer such as a personal computer, laptop computer, or a tablet computer for communicating to the Internet Server 40 and/or the cellular phone node 42. Such communications occur via communication links 80, 81, and 82, as depicted on FIG. 1. These are typically high-speed Internet links, or high-speed cellular phone links, although the cellular phone links almost always will involve data rather than voice types of communications. All available types of Internet communications and cellular phone communications protocols can be included in system 10. The professor's computer will typically include a processing circuit, a memory circuit, a display, a data entry device such as a keyboard and/or a mouse or other type of pointer device, a communication port, an imaging (digital) camera as an optional component, and a microphone as an optional component. The use of the optional camera and microphone will be discussed in greater detail below.

The hardware device 60 represents some type of computer that will be used by a registered student. In general, such computers will be a tablet computer or an iPad, or some other type of wireless computer using a protocol that has yet to be invented or trademarked. Such student computers will typically have a processing circuit, a memory circuit, a display, a data entry device such as a keyboard and/or a mouse or other type of pointing device (e.g., some type of touch pad on a portable computer such as a laptop), a communication port, an imaging (digital) camera, and a microphone. The last two components will not necessarily be used in all classes or courses in system 10, but it will probably be a requirement for each student's computer 60 to include those devices at most schools, so that the student will have the ability to register for advanced courses that will need those types of input or recording devices.

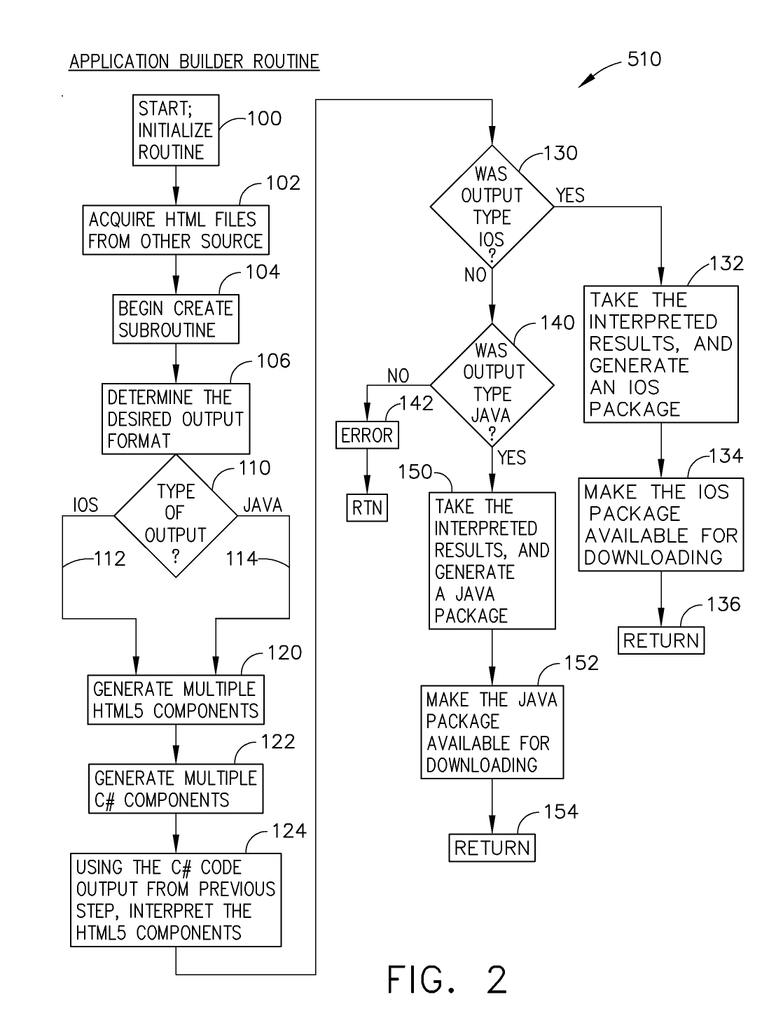

The hardware of the computer system 10 is designed to allow a professor (or a group of professors) to create a college-type course that will be offered by the school to students who will take that course using on-line types of technology. Each of the learning courses will be created using an application builder routine (which is described on FIG. 2), and that application builder routine will create an application program that typically is referred to herein as an “APP.” The professor creates a complete college-type course as an APP, and the students will then load that APP onto their tablet-style computers. Once the student has the APP, that student can “take” the course by studying the APP lectures at the student's own pace. However, in some courses, there will be some real-time components, including certain lectures for certain types of courses. This will include certain courses with advanced functions including a “synchronous lecture routine,” which will be described in greater detail below. The synchronous lectures must be “taken” in real time, because there will be two-way communications between the professor and the students, and that will occur in real time.

Referring now to FIG. 2, an application builder routine is depicted as a flow chart showing some of the important steps in this routine. Beginning at a “start” step 100, the computer used by the professor initializes the routine. At a step 102, the computer building the routine acquires HTML files from other sources. Those other sources will typically include the professor, but can also include other types of content, including tables, photographs, other types of mathematical data, verbal content, such as pages from a text book or entirely new verbal displays, such as PowerPoint presentations. Once the professor has either acquired or designed all of the HTML files that are to be used for this particular course, a step 104 begins a “create” subroutine. The next step now is to determine the desired output format at a step 106. A decision step 110 asks what type of output is desired. As envisioned today, there are two choices: either IOS, or Java. If IOS, the logic flow travels down a line 112 to a step 120 that generates multiple HTML5 components. The same sort of thing occurs if Java is the desired output, and that follows a pathway 114 to the step 120. The next step 122 generates multiple C-Sharp components. (Note, this patent document will typically refer to the C-Sharp software as “C#”.) A step 124 now uses the C# code output from the previous step to interpret the HTML5 components that were generated at step 120.

A decision step 130 is now reached that asks whether the output type was IOS. If YES, then a step 132 takes the interpreted results and generates an IOS package. A step 134 now makes the IOS package available for downloading. The logic flow has now reached the end of this application builder routine and returns to other processes at a return step 136.

If the output type was not IOS, then the logic flow travels from step 130 to a decision step 140, which asks if the output type was Java. If NO, then this is an error at 142, and the logic flow returns to other functions. (This sort of error should not occur unless there has been some type of data entry error or format error in the content that was being provided to the create subroutine.) Assuming the output type is Java at step 140, then a step 150 takes the interpreted results and generates a Java package. This Java package is now made available for downloading at a step 152, after which we have reached the end of this application builder routine at a return step 154. Once the IOS package or the Java package is available for downloading, that means that a registered student 60 (see FIG. 1) will now be able to access the Internet server 40 and the cellular phone node 42 to download the college course, via the communication links 90, 91, and 92. It will be understood that the IOS packages will typically be used by tablet computers that use Apple-type operating systems (e.g., iPad-type devices) and that the Java packages will typically be used by tablet computers that run Android-style operating systems.

In the computer system 10, the student has a choice of downloading the APP in advance of studying the college course, or the student can communicate to a learning management platform (one of the private company service providers 30) and select a button on that platform to connect to the APP and immediately begin studying the course. As noted above, for a type of course that uses the synchronous lecture routine, the student will have to connect to the system servers at designated dates and times.

Once the APP has been downloaded onto a student's table-style computer 60, the APP will track the student's progress, even when the student is off-line. For most of the courses, the student will be able to study while off-line, and will even be able to take tests and exams while off-line. However, at some point the student will need to communicate back to the school's computer system 20, and the student's computer 60 will look for a WiFi connection so that the student can wirelessly connect into the Internet server 40. Once a student is connected into the school's dedicated server 22, the student will be able to upload exam test results and other information that may be required by the professor for that course. Some of the functions of the student user's APP will now be discussed in detail.

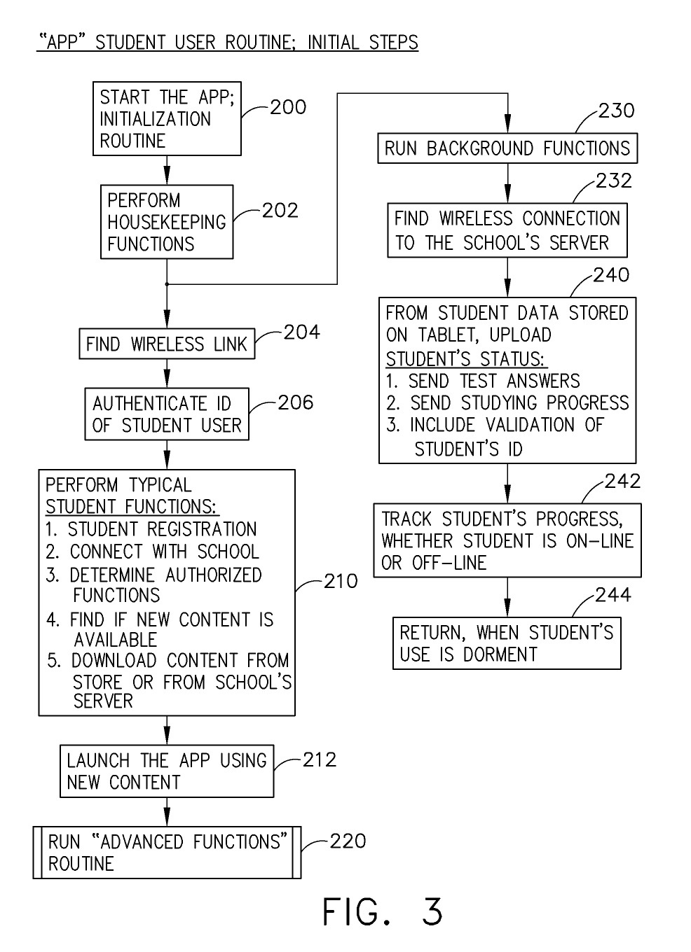

Referring now to FIG. 3, some of the initial functions of the student's APP are described as a flow chart. Beginning at a step 200 the APP is started by an initialization routine. At a step 202 housekeeping functions are performed, for this particular college course. In a first direction of logic flow, a wireless link is sought and found at a step 204. The identification of the student user is then authenticated at a step 206. Once that has occurred, a step 210 allows the student to perform certain typical student functions, such as registration, connecting with the school for other purposes, determining authorized functions, finding if new content is available, and downloading content from the “store” (e.g., from one of the private company service providers 30) or from the school's server 22. Once all the above has occurred, the APP can now be launched using new content at a step 212. At this point in the logic flow, the APP represents a specific college course that has been created by a specific college professor for on-line education purposes, for use by this particular student.

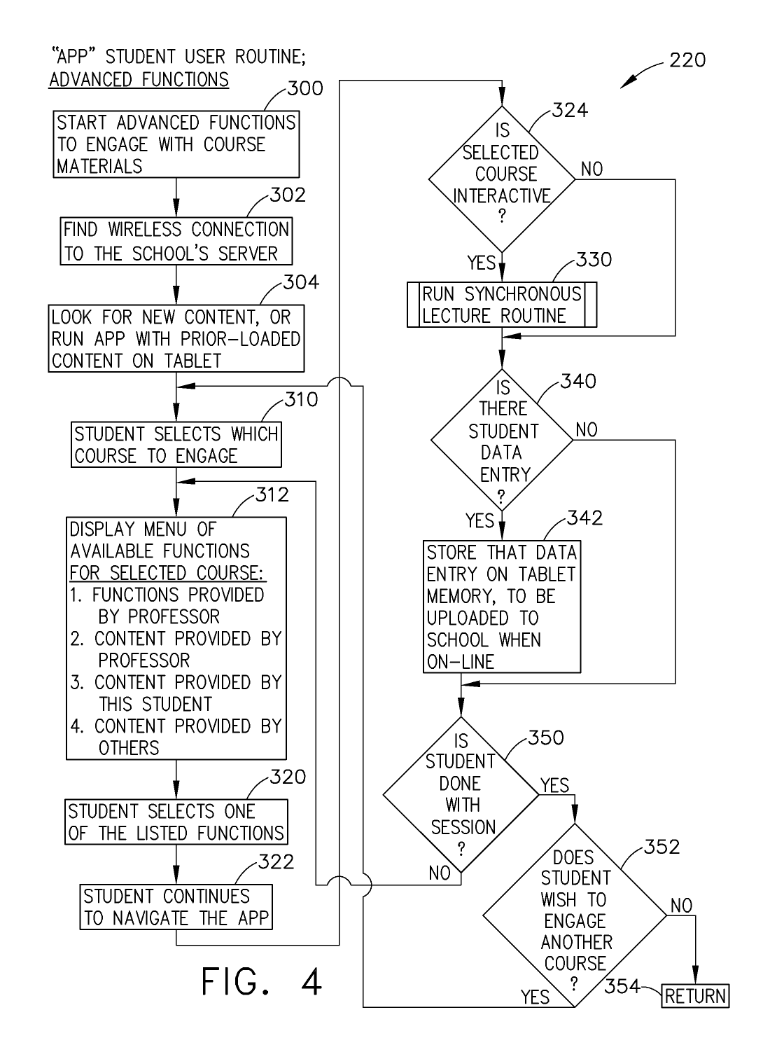

The student can now run “advanced functions” routines at a step 220. Such advanced functions routines are described in greater detail below—see FIG. 4.

A second branch of the logic flow on FIG. 3 can occur after the housekeeping functions are performed at step 202. At a step 230, background functions are executed, and these are functions that can occur in part while a student is off-line. However, the APP will specifically run background functions that can occur only when the student's tablet computer is connected to the school's server. Some of these background functions may occur without the student even realizing it—an intentional result and feature of this system.

At a step 232, the APP seeks a wireless connection to the school's server. Once that connection has been made, a step 240 uploads the student's status based on student data that has been stored on the tablet computer. Such student status data includes test answers, the progress of the student's studying, and validation of the student's identification information. Each school may have a different protocol for validating the student's identification, but that can include photographic ID information, which is why an imaging (digital) camera is part of the student's tablet-style computer. The studying progress information will be available to the student's tablet computer, because that tablet computer knows if the student has actually been reading the course content that was provided by the professor as part of the APP download. The test answers are content that is generated by the student himself or herself, and these test answers will be stored in the student's tablet computer and uploaded, either by the student manually, or will be uploaded later automatically by the tablet computer when it is connected into the school's server. The choices of how this occurs can partially be made by the students, but obviously the test must be taken by the student and then his or her answers uploaded to the school, or the student will not complete the course.

Other types of biometric data can be used to identify the student, if desired. Many laptop computers have a fingerprint sensor, and other types of tablet computers may well incorporate such biometric sensors. If desired, the school can allow such biometric data to be used in the student identification, either to supplement or to replace the photographic data. Finally, a student's voice print could be used as well, using the microphone of the tablet computer as input data.

The tablet computer using the APP will also track the student's progress at a step 242. This will occur whether the student is on-line or off-line, while the student is studying the course materials. The reporting of the student's progress will occur according to criteria that is determined partially by the school and partially by the student. In virtually all courses, however, the student's progress will be uploaded to the school's server automatically as a background function, if the student has not manually done so himself or herself by a prescribed time.

When the tablet computer uploads status information to the school, it does not necessarily have to go directly to the school's server 22. There can be other external learning management systems (LMS), such as the BlackBoard brand of learning management systems. Other brands of LMS systems are also known, and can be used by a student to upload data that will ultimately be part of the student's grades for the college course. A brief list of some of the available major LMS brands includes: Sakai, Moodle, and Desire2Learn.

When the student's use becomes dormant, this routine will return at a step 244. Note that these are “initial” steps of the student's APP, and there are many other more advanced steps to be discussed (see below).

Referring now to FIG. 4, a flow chart showing some of the advanced functions of the APP student user routine are described. Note that this entire flow chart is also generally designated by the reference numeral 220, which appears on FIG. 3. Beginning at a step 300, the APP begins the advanced functions that are used to engage with course materials. For the student to engage with the course materials, a wireless connection to the school's server must be found, at a step 302. Once that has occurred, a step 304 looks for new content, or the APP will run with prior-loaded content on the student's tablet-style computer. At a step 310, the student now selects which course to engage at this time.

At a step 312, the student's tablet computer will display a menu of available functions for this selected course. Such available functions will include functions that are provided by the professor, content that is provided by the professor, content that is provided by this student, and content provided by others, including other students taking the same course, for example. The student now selects one of the listed functions at a step 320. In general, such listed functions will appear on a display of the tablet computer, typically in the form of a menu or other easily selectable set of choices. The student now continues to navigate the APP at a step 322.

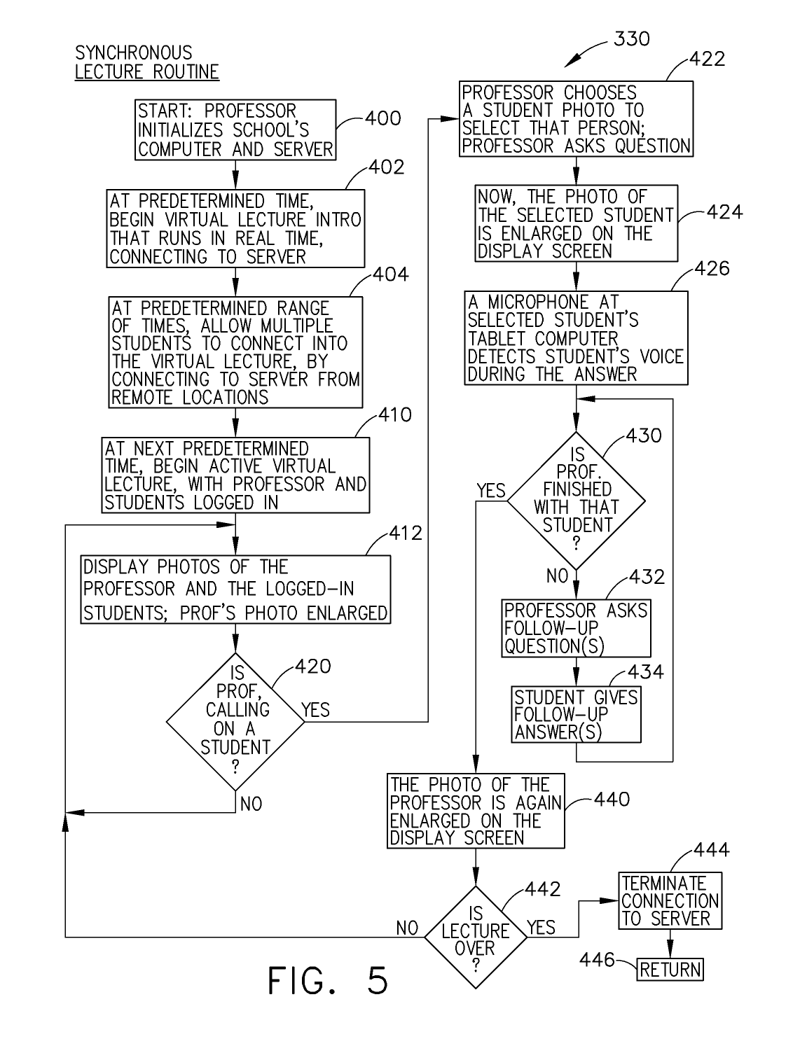

The student now comes to a decision step 324 that asks if this selected course is interactive. If so, the student needs to run a routine referred to herein as the “synchronous lecture routine,” at a step 330. This routine is described in some detail on FIG. 5. Whether or not the selected course is interactive, the logic flow is now directed to a decision step 340.

At step 340, the APP determines whether or not there is student data entry involved. If YES, then that data entered by the student is to be stored on the tablet computer's memory, to be uploaded to the school when this tablet computer is on-line, at a step 342. The next function is a decision step 350 that determines if the student is done with this session. If NO, then the logic flow is directed back to the display of available functions for this course, at step 312. If the student is done with this session, then the logic flow is directed to a decision step 352 that asks whether the student wishes to engage with another course. If so, then the logic flow is directed back to step 310 that allows the student to select a different course to engage. Or if the student is actually finished overall, then the logic flow is directed to a return step 354.

An example of the power of the APPs that will be used in this system will now be discussed. At step 312 on FIG. 4 it was noted that there are several different types of available functions or types of content that can be provided while running the advanced functions of the student user routine of this APP. These types of content and functions can be mixed together into one large menu, if desired, and the student can choose from that menu as one of the listed functions, as described at step 320. As an example of a display listing a menu of available functions or types of content, one selected college course could have a display such as that immediately below:

(1) Home—shows the course title, with professor's photograph

(2) Syllabus—lists weekly progress; book chapters

(3) Lectures—PowerPoint displays; video clips, etc.

(4) Presentations—PPT presentations, other content

(5) Audiocasts—audio lectures

(6) EBooks—the textbook pages, other course materials

(7) Class Materials—word files, PPT files, etc.

(8) Assignments—lists tasks; space to enter new papers or other content

(9) Notes (personal)—per chapter (these can be shared)

(10) Class Notes—from other students (posted)—several chapters (free format)

(11) Assessments (“Chapter Review Quiz”—visual test: multiple choice)

(12) Badges (“Assignment Complete,” “Assessment Passed”—designators for various assignments, per chapter, or per other milestone

(13) Community—announcements, blogs, news feeds, chat, discussion boards)

Referring now to FIG. 5, a flow chart is provided for a synchronous lecture routine that is simultaneously run on the professor's computer system 50 and the registered student's computer system 60. Beginning at a start step 400, the professor initializes the school's computer and server in preparation for this particular lecture. At a step 402 the virtual lecture begins with an introduction screen at a predetermined time by connecting to the server and by beginning the virtual lecture introduction that runs in real time on that server. At a step 404, during a predetermined range of times, the system will allow multiple students to connect into this virtual lecture by connecting to the server from various remote locations. This is equivalent to the student running the step 330 on FIG. 4. In fact, on FIG. 5, this overall flow chart is also referred to by the reference numeral 330. At a step 410, at a predetermined time the active virtual lecture begins with the professor logged in, and with all of the students logged in. Again, this occurs in real time, and thus is synchronous for everyone involved.

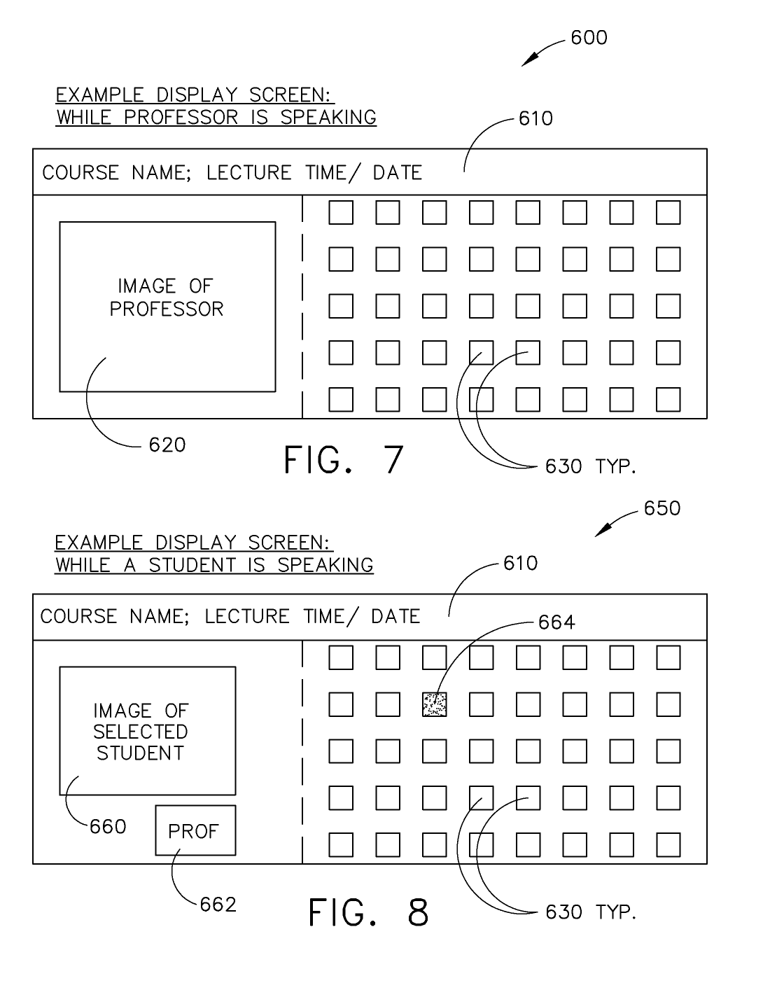

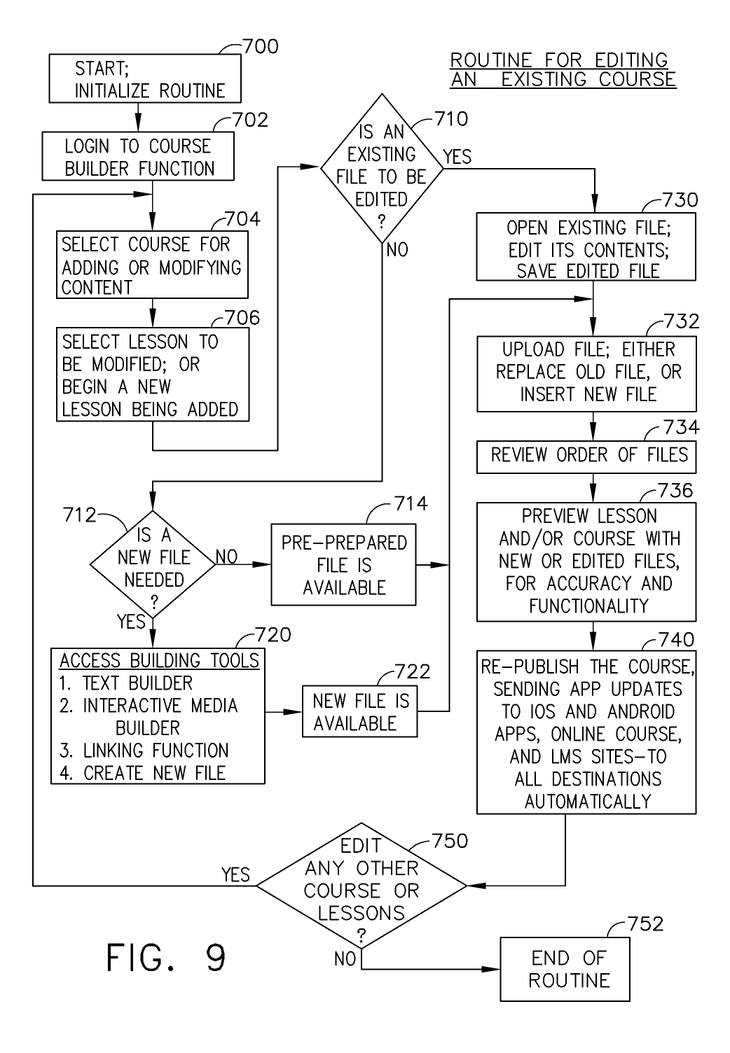

Each of the students' photographs and also the professors' photograph are now displayed on everybody's computers, at a step 412. Initially, the professor's image is enlarged, and all the students have their photographs in much smaller thumbnail images. An example of this type of display is given on FIG. 7, designated by the reference numeral 600. This type of display will continue so long as the professor is speaking. However, there may come a point in this lecture where one of the students will be speaking, and in that situation the image of the student who is speaking will become enlarged, and the professor's image will become a smaller thumbnail image. An example of this type of display is provided on FIG. 8 at the reference numeral 650.

A decision step 420 now determines if the professor is calling on a student. If not, then the logic flow is directed back to step 412 and the professor's image is still enlarged as compared to the thumbnail images of the logged-in students. On the other hand, if a student has been called on, then the logic flow is directed to a step 422 where the professor chooses a student's photo as the act of selecting that person to speak. (This could be done using a mouse and clicking directly on that student's image.) Now the professor asks a particular question of that student. This is a typical scenario in a lecture that uses the Socratic method, such as practiced in many law school classes. When that occurs, the photograph of the selected student becomes enlarged on the display screen at a step 424. This display is now used at everybody's computer screen, not only the professor's but also those of all the students. A microphone at the selected student's tablet computer will be used to detect the student's voice so that student can answer the professor's question. This occurs at a step 426.

Note that, as an alternative feature, real time video images could be used on the display screens, instead of a “still” thumbnail image, per person. This alternative (and preferred) approach would require a digital (or video) camera at each computer, and the speakers (e.g., the students and the professor) would need to remain at relatively fixed locations so they would (constantly) be in view of their individual cameras. When using this alternative feature, the “live” video images can be shared with all the participants of the synchronous lecture in real time. Therefore, the exemplary display screens of FIGS. 7 and 8 would contain multiple “live” video images at 620, 630, 660, and 662, for example. (See below for more detailed information, regarding FIGS. 7 and 8.)

After the student answers the question, a decision step 430 determines if the professor is finished with that student. If not, the professor can ask a follow-up question at a step 432, and the student can give a follow-up answer at step 434. After each follow-up question and answer the logic flow is directed back to decision step 430 that determines if the professor is finished with that student. Once the answer becomes YES, then the logic flow is directed to a step 440 and the photograph of the professor is again enlarged on the display screen for all of the students and for the professor. A decision step 442 now determines if the lecture is over; if not, then the logic flow is directed back to step 412, and the professor can continue his or her lecture, and also has the opportunity to call on a student once again. On the other hand, if the lecture is over, then a step 444 terminates the connection to the server of this synchronous lecture. The functions of the computer system now return to other functions at a step 446.

It will be understood that the steps 430, 432, and 434 can occur as stated above, or can cause the enlarged image to bounce back and forth between the professor and the student each time one of the steps 432 and 434 occurs for follow-up questions and answers. Since this is an educational learning experience, and not a television show, the professor may decide that there is no need to have the larger image bounce back and forth between the professor and the student who is being called upon, and instead the student's image can remain as the enlarged image through all of these follow-up steps. Any combination of these types of image enlargements falls within the considerations of the technology disclosed herein.

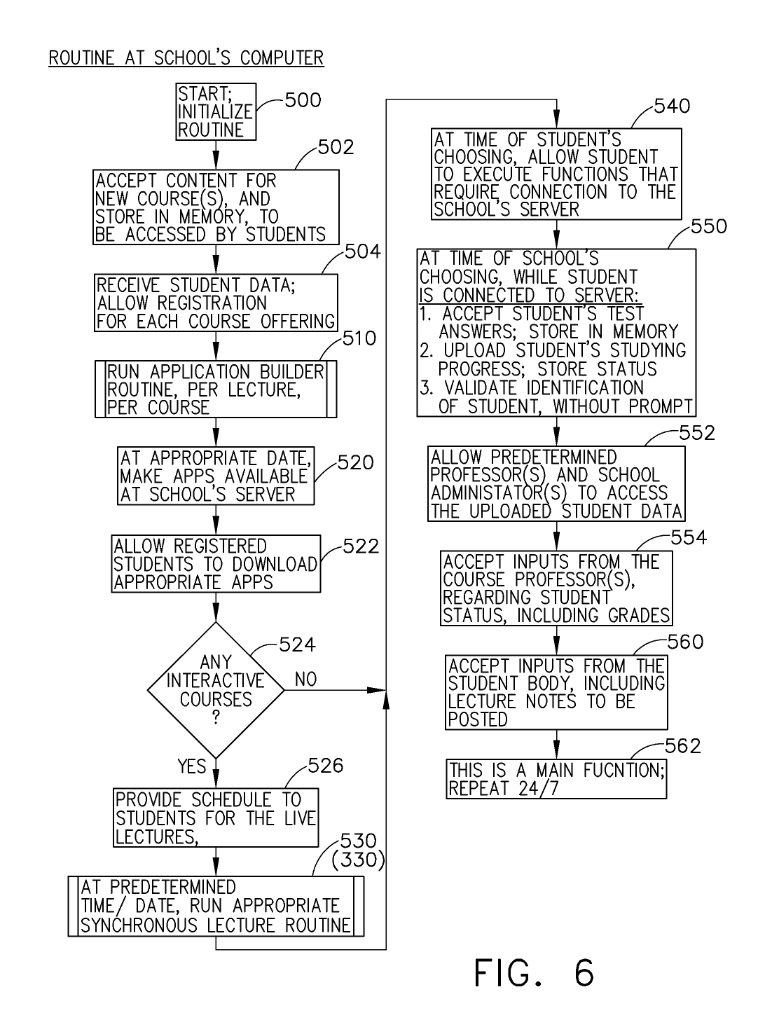

Referring now to FIG. 6, the main steps of a routine that runs at the school's computer are described as a flow chart. Starting at a step 500, the school computer runs an initialization routine. A step 502 accepts content for new courses, and stores that content in memory, to be later be accessed by students. A step 405 receives student data, and allows the students to register for each of the course offerings. A step 510 now runs the application builder routine, per lecture, per course. This application builder routine was discussed above in relation to FIG. 2. In other words, the entire flow chart of FIG. 2 can be represented by this step 510.

Once the lectures for a course have been built by the application builder routine, at an appropriate date a step 520 will make the APPs available at the school's server. Registered students will now be allowed to download the appropriate APPs at a step 522. Each APP can represent an entire multi-lecture college course.

A decision step 524 now determines if there are any interactive courses involved for a particular student who is attempting to download an APP. If not, then the logic flow is directed to a step 540, discussed below. If so, then a step 526 provides a schedule to the inquiring student of when the live lectures will occur. A step 530 will now run the appropriate synchronous lecture routine at the predetermined time and date listed on the schedule. Step 530 is essentially the same as 330, which, as noted above, is the same thing as the flow chart of FIG. 5.

At step 540, at a time of the student's choosing, the student may execute the functions that require connection to the school's server. Furthermore, at a step 550, at a time of the school's choosing, and while the student's tablet computer is connected to the server, the school system can accept student test answers and store them in memory at the school computer, upload the student's studying progress and store that status in memory, and also validate the identification of the student without any prompt of the student. This last validation routine will generally take place without the student being aware. Again, a camera or other type of biometric device will be required at the student's tablet-style computer. The preferred methodology at this time is to use a camera that can take a snap shot of the student at any time, and (again) without the student having knowledge of that occurrence.

A step 552 now allows predetermined professors and school administrators to access the uploaded student data. At step 554 accepts inputs from the course professor(s) regarding student status, including grades. At step 560 now accepts inputs from a student body, including lecture notes that are to be posted. And a step 562 indefinitely repeats all of these available functions, because this entire routine is a main function of the school's computer and must be available all the time, if possible.

Referring now to FIG. 7, an example computer display screen is depicted while a professor is speaking for one of the synchronous lectures. (Of course, such display could also be provided for a professor speaking a unidirectional lecture, in which there are no students answering questions. In other words, this type of image could be provided as part of the typical content of a lecture session for one of the courses. The main purpose of this type of display would be to show images of the other students in the class, if that would be a desired feature.)

A top display bar 610 will list the course name, and the lecture time and date. The large image of the professor will be displayed at 620, in this instance, on the left-hand side of the screen. Multiple thumbnail images of the students will then be displayed as an array, as shown by the reference numeral 630. The professor can be allowed the flexibility to arrange the students in some sort of seating chart, if desired. Typically, the students might be arranged in alphabetical order of their last names.

Referring now to FIG. 8, an example computer display screen is provided to show what the appearance would be while a student is speaking, typically to answer a question by the professor. Again, the top display bar shows the course name, and lecture time and date at 610. Once the student has been selected from the array of students 630, that student's image will be enlarged and moved to the left side of the screen at 660. The professor's image will now be shrunk to a smaller size and moved to a location at 662. (Of course, the professor's image 662 could be moved anywhere on the screen, or even eliminated from the screen altogether, if desired.) The reference numeral 664 designates the location of the selected student and can highlight that student in the array of students 630, or it could essentially obliterate or delete that student's image altogether, if desired. This could be a menu choice selected by the professor while setting up this synchronous lecture course. In other words, it could be part of the application builder routine 510, as described above in reference to FIG. 2.

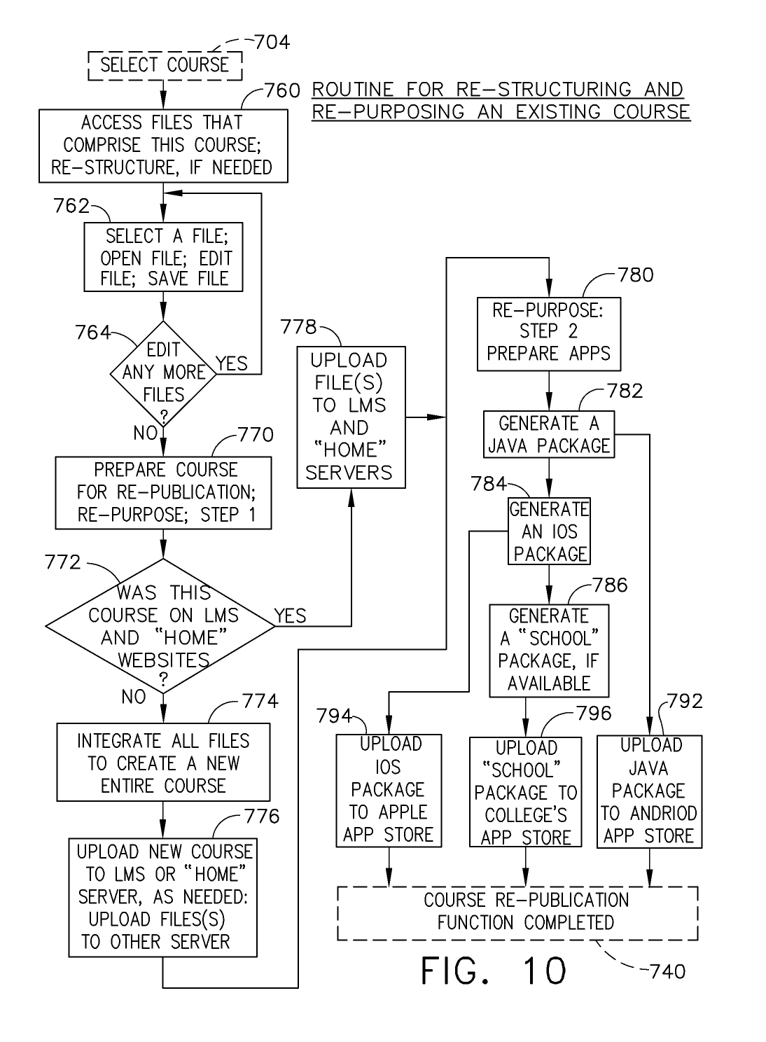

Referring now to FIG. 9, the main steps of a routine for editing an existing course are described as a flow chart. Beginning at a step 700, the editor's computer runs an initialization program. It should be noted that the particular computer used for this function would typically be the professor's computer, but it could be done by another authorized person using another physical computer, if desired. Typically here would be done using either a professor computer or a school computer, but as a minimum, it must be a computer that is being used by an authorized person who is allowed to edit the course in question. Generally speaking, whichever computer that is permitted to access the memory device that the courses are stored on for that school or university, that will be the computer that needs to be accessed, and (typically) a different computer (e.g., the professor computer) will be used by this editing routine to do the actual edits to the course files.

At a step 702, the authorized user (typically a professor or instructor) will LOGIN to the course builder function. The professor will now select a particular course for adding or modifying its content, at a step 704. Since existing courses are already divided into separate lessons, it would be typical for the professor to select a specific lesson that is now to be modified. Alternatively, the professor may desire to add a new lesson that was not in the original course at all. Both of these possibilities are addressed at a step 706, in which either an existing lesson, or a new lesson being added, is selected.

Each lesson is divided into multiple files, and a decision step 710 is where the professor decides whether or not an existing file needs to be edited. If the answer is YES, then the logic flow is directed to a step 730 where that existing file will be opened. On the other hand, if an existing file is not to be edited at this particular time, then the logic flow is directed to another decision step 712, where the professor decides whether or not a new file is needed at this time. It could be that the professor already has prepared a file that is available for use in this editing routine. In fact, that likely will be the typical situation. If that is the case, then the logic flow is directed from decision step 712 to a step 714 that confirms that a “pre-prepared” file is available for the purposes of editing the lesson. On the other hand, if a pre-prepared file is not available at this time, then a new file is needed, and the logic flow is directed from decision step 712 to a new step 720.

At step 720, the professor will access the “building tools” of the main software product that makes up at least a portion of the application builder routine. In other words, the application builder computer software that is described above can be made available at this step if desired, or only a certain portion of that type of software can be made available, depending upon the exact arrangement at has been made in advance between the particular university or school and the software provider of the application builder computer software. As a minimum, certain access building tools are needed, such as a text builder function and an interactive media builder function. For example, the text builder function can contain a text editor computer program (such as Microsoft Word), or it could contain a different sort of text building program, such as Adobe Acrobat Reader, for creating PDF files. The interactive media builder function would have the capability of creating or editing all sorts of different types of files. In general, a full capability system will include the capability of editing or creating at least the following types of files: (1) video files, (2) YouTube-video files, (3) “Vimeo” files, (4) web link files, (5) HTML files, (6) document and image files, and (7) the professor's own video files. Examples of document and image files could be Word files, PDF files, JPEG files, and other types of files that contain images or text. The professor's own video files could have any number of various formats, including such industry standards as MOV files, WMV files, or MP4 files, for example.

The file being created might have more than one component, and each of those components might be created using a different type of text builder or interactive media builder function. In that situation, the individual components or objects that create this file need to be linked together so the software of the application builder system will provide a linking function, and the ultimate result will be the creation of a new file. Therefore, the output from step 720 is a new file that will now be available to the system. That status is noted at a step 722.

As noted above, the professor may desire to edit an existing file, and in that situation there would be no pre-prepared file (such as at step 714) and there would be no newly created file (such as at step 722) that is available at this particular moment. Therefore, a function step 730 allows the professor to open an existing file in the lesson that is being edited. Once that file has been opened, the professor can edit its contents and then save the modified file. It will be understood that, for the professor to be able to accomplish these editing functions, then the professor computer or school computer being used for this editing task must include some type of native computer software that will be able to literally edit the file being selected by the professor at steps 710 and 730. For example, if the professor desires to edit a Word file, then the computer being used by the professor will need to include the Microsoft Word word processing software (or some equivalent). If the file being edited is a spreadsheet file that was generated by Excel software, then the professor's computer being used for this task must include the Microsoft Excel spreadsheet processing software (or some equivalent). Once that editing function has been completed, the modified file will be saved by the professor's computer or the school's computer, depending on which computer is being used for this editing task.

At this point, the file of interest needs to be uploaded to the system, and this is accomplished at a step 732. The file being uploaded is either the file that was just edited at step 730, or it is a pre-prepared file from step 714 or a new file from step 722, which are now made available for this upload step. Once the file has been uploaded, that file will be integrated into the lesson that was selected back at step 706. If the professor desires to completely replace an old file of that lesson, then that old file will be deleted or moved, and the new file will be inserted in its place. On the other hand, the professor may desire to insert a new file without touching any of the original files that were already in that lesson. That desire also can be accomplished, and the insertion of a new file can either be at the beginning or end of the lesson, or if desired, it can be literally inserted between other files.

Once these functions have been accomplished at step 732, the professor will now have the capability of reviewing the order of files at a step 734. The system can have the capability to review all files for the entire course. If something has not worked out quite the way the professor expected, then the files themselves can be edited using step 730, or the order of files can be modified at this step. Once the professor believes that the order of files is correct, then the professor can preview the lesson and/or the entire course with the new or edited files, for accuracy and functionality, at a step 736. Once the professor is satisfied after previewing the lesson, the course can now be re-published, at a step 740.

As discussed above, the original application builder routine creates Java packages and IOS packages, and such packages can be downloaded to users with mobile computers. Also, similar courses can be made available through an online website, and such courses can also be used at LMS sites. The functions at step 740 include sending the re-published course as APP updates to IOS and Android APPs, online courses, and LMS sites. This comprehensive re-publication occurs automatically, in this single function step, to all such destinations in the appropriate format of data for each of those desired destinations.

Once that has occurred, the editing routine reaches a decision step 750 to ask the professor if he or she desires to edit any other course or lesson. If the answer is YES, then the logic flow is directed back to step 704 where the professor selects a course for adding to or modifying its content. If the answer is NO at step 750, then the logic flow has reached the end of the routine at a step 752.

Referring now to FIG. 10, a flowchart is provided showing more specific details for a routine that re-structures and re-purposes an existing course. This routine is essentially a portion of the editing routine depicted in FIG. 9, and it shows some of the more detailed functions between the steps 704 and 740.

Beginning at a step 760, after the course has been selected at step 704 on FIG. 9, the files that comprise this course are now accessed, and they are re-structured, if needed. The act of re-structuring the course is mainly to present a plurality of individual files to the user who is performing the editing of that course. In the terminology of FIG. 2, this person would typically be a college professor, if the target audience or “student” is to be a college student. However, it should be understood that a college student is not the only potential audience, as this system could be used by businesses or government entities, for example, in which the “student” could be a trainee and the “college professor” could be a trainer of a non-college course. In this situation, that college professor or trainer is performing an editing function, so that person is truly an editor.

The important principle at step 760 is that the course should be re-structured into individual files, unless individual files are made immediately available after the course has been selected at step 704 on FIG. 9. If the course was originally built by a course builder function provided by AlvaEdu, then the files will already be made available as individual structures, and the user/editor will be able to see those files on his or her computer screen at the professor computer. On the other hand, if the course was originally built by a college professor and then stored and made available to students through an LMS (learning management system) such as BlackBoard, then the individual files may not be structured properly; in that event, the system that is performing the editing function must now re-structure those files, so the user/editor can have easy access to each individual file, as needed. It also would be possible for a college to make its learning files available on APPs only, in which case the individual files that originally made up the APP may not be readily structured for ease of access of the individual files.

In any event, the act of accessing files at step 760 will typically involve the user/editor using a professor computer, and the files themselves that are being accessed are stored on a school computer or, if the files are stored in another system, such as the cloud, then that school computer is the device that has access to the location of those files. In any event, there are at least two computers involved in this accessing files step 760. Typically a communication pathway between those two computers would be a secure Internet link, although a private data link also could be used.

Once the file structure has been provided to the user/editor, the editor can select a specific file at a step 762. That file can be opened, edited, and then saved, all within step 762. It would be typical for the user/editor to have available at his or her computer (i.e., the professor computer) the appropriate native software for editing that particular type of file. For example, if the file is a text file saved as a Word file, then the user/editor would preferably have some version of Microsoft Word operating at the professor computer, so that the Word document could be easily edited by that word processing software. It will be understood, however, that other types of word processing software might also be able to act as “native software,” to edit a Word file. For example, some more advanced versions of WordPerfect would be able to open a Word file and edit that file, and then save it again in a Word format, just as if the WordPerfect software had been a Microsoft Word software program. The same would be true for other types of file formats, such as video files, voice files, and image files (such as PDF files). In general, all of the functions listed in step 762 would take place using the professor computer, although it would be possible for that computer to be accessing, opening, and saving files in the cloud, which would involve yet another remote computer in some situations.

After the first file has been saved at step 762, the user/editor now decides whether or not he or she wishes to edit any other files, using a decision step 764. If the answer is YES, then the logic flow is directed back to step 762 where that user/editor can select a second file. These procedures are used over and over to edit as many files as desired. Once the user/editor is finished with all of the files for this course, then the logic flow is directed to a step 770 that prepares the course for re-publication. This is the first step in re-purposing the course.

A decision step 772 now determines whether or not this course was resident on both an LMS and a “home” website. In answering this question, the “home” website could be a website resident at alvaedu.com, or at courseflow.com, which is a portion of the alvaedu.com website. An LMS site would be one such as BlackBoard that may handle some of the college's online courses. If the course that was selected back at step 704 on FIG. 9 was already resident on both an LMS and a “home” website, then there is no need to integrate all the files to create a new course, except for the APPs. Therefore, the specific file that was just edited can now be uploaded to both the LMS and the “home” servers at a step 778. This step 778 would be used for all of the files that were just edited, whether there was only a single file edited or multiple files, as noted back at the decision step 764. Once these files have been uploaded at step 778, the system is now ready for the second step of re-purposing, at a step 780.

If the answer at decision step 772 was No, then the original course selected at step 704 was resident only on one of the types of websites, either the “home” website or an LMS site. Therefore a step 774 is used to integrate all of the files to create a new format for that course. If the original (unedited) course that had been selected at step 704 was resident only on an LMS site, then this routine of FIG. 10 will now create a new format for being stored at the “home” server as an entire course. On the other hand, if the course that had been selected at step 704 was resident only at a “home” server, then step 774 will now create a new format that can be stored at an LMS site as an entire course. After all of this has occurred, a step 776 will upload the newly edited course to the LMS site or to “home” server, as needed. Of course, the site that had the original unedited course does not need to have a new course of integrated files created, but can instead receive only a single new or edited file (or multiple such files) to be uploaded to that server.

It will be understood that the act of uploading the course to an LMS or a home server will involve the school and professor computers, in which the professor computer (the editor's computer) has first saved the files, and then either an individual file or an entire course will now be uploaded to the school computer, where the course was originally stored, or where a re-purposed course will now be stored where it was not stored beforehand. (The school computer might rely on a private company service provider to control the storing of these files, and the cloud might be used as the physical storage facility.)

Referring now to step 780, the second step of re-purposing the course is to prepare the APPs. A Java package will now be generated at a step 782, and that Java package can now be uploaded to the Android APP Store, at a step 792. An IOS package is now generated at a step 784, and that IOS package can now be uploaded to the Apple APP Store at a step 794. A future type of “school” package might someday be available at some colleges, in which APPs can be uploaded to the school's own APP Store, if that eventuality should occur. If that someday becomes a reality, the “school” package might have a different format from either a Java package or an ISO package, and such a school package could be generated at a step 786, and then after it is made available, that school package could be uploaded to the college's APP Store at a step 796.

It will be understood that steps 780 through 796 would generally be executed on the editor's computer, which is also referred to herein as the professor computer. The various types of APP stores are remote devices, which are well known in the case of the Android APP Store and the Apple APP Store. If the college should happen to create its own APP store, that would be part of the college's computer system, which could be the school computer that was discussed above. On the other hand, the college's own APP store could be an entirely separate system altogether, both physically and virtually with respect to memory storage locations and addresses.

As noted at step 740 on FIG. 9, all of these re-publications are to occur automatically and virtually simultaneously. It is preferred that course re-publication occur seamlessly, of course; it would be preferred that the end user (which in this case would be the “student user”) would not notice that a change had been made to a course that the student user might have already had open while the editing functions were being performed. This would be a function of the LMS site and the “home” website, and also of the APP stores. Such host devices will have to decide for themselves how the now newly edited course will be presented to the users at their student computers. Once the APPs have been uploaded to their various appropriate stores, the course re-publication function has been completed, as indicated at step 740 on FIG. 10.

The editing functions described in the flow charts of FIGS. 9 and 10 can be used for both pre-prepared files and for files that are modified “in real time” by the professor/instructor. In either event, it is significant that the re-publication of the courses occurs in near real time, and in a manner that is transparent to the student users, and also that will be entirely seamless (hopefully) every time. In essence, these functions are a form of “live editing,” because the modification and re-publication functions will occur after the course was initially published, and will modify that course quickly (in real time) so that the student users will probably never know that an updated course has suddenly appeared on the LMS website or “home” website, or at the Apple or Android APP store.

Moreover, it is probable that the professor would modify only those courses that are in the future of a student's studying progress, so it might be that no student would have ever seen the original (non-updated) lesson. The courses will be designed so that the professor can limit exactly which lessons are made available to the students during the term of study (i.e., during a particular week of a semester or quarter of school classes). Therefore, if a professor performs “live editing” on a lesson that has not yet been made available to the students for studying, then (of course) no student user will notice that an updated version has suddenly appeared at the website or the APP store.

The students who study using one of the course APPs, such as an Apple APP or an Android APP, have the capability to save those course APPs on their portable computers if they so choose, when using the technology disclosed herein. Therefore, such students are able to study while their computers are off-line, such as when they are traveling in an airliner. This is a feature that has not been available from LMS websites; in the existing LMS systems, the students could only study their courses while on-line.

If a professor performs “live editing” on a lesson for one of that student's courses, then that student's portable computer will need to be updated. The software system is designed to automatically determine whether a newer version of each of the student's course APPs is now available, the next time that student's portable computer logs into the system. The software system is also designed to automatically download that newer course APP to that student's portable computer, so that the next time that student begins to study that particular course, then a second (updated) version of the educational content for that course will be made available to the student, using the revised (newer) APP. Assuming the student was not viewing the “old file” that was specifically modified by the “live editing” procedure, then this replacement of the new APP for the old APP should be seamless, and transparent to the student user.

The term “multi-media course” as used herein generally refers to a set of computer files that have different format types. For example, if the course comprises only two files, if file number 1 is a text file, and if file number 2 is a video file, then that qualifies as a multi-media course. It would be typical for each lesson of a course to contain multiple files of different format types; however, it certainly is possible for a particular lesson to contain only a single file format type. For example, a lesson might contain a single video file, or a lesson might contain a single image file, or a lesson might contain a single text file. In one of those situations, one of the other lessons for that course would include a file format type that is different, thereby making the overall course a multi-media course. Many people consider video files alone to be multi-media files, because they contain both image information and audio information. Video files will be common in the systems described herein, as lectures, or to present information by outside speakers, etc.

It will be understood that the “home” website is a term used in conjunction with FIG. 10 to describe a special type of private company service provider having a computer system that is capable of building college courses, as per the steps of the flow chart of FIG. 2, for example. Such a computer system could generically be called a “home” computer system, not because it is to be used by a human user at his or her home, but because it uses a computer that is part of the overall (home computer) system which also includes a “home” website and a “home” web server (or simply, a “home” server).

A standard LMS service provider might be capable of some of the functions that are described above, with reference to FIG. 10; however, many of the functions described on FIG. 10 will likely only be available from a service provider called AlvaEDU, Inc. located in Boca Raton, Fla. AlvaEDU will have course building capabilities, and also will have course editing capabilities, using one of its “home” websites. For example, a “home” website can be allocated for each individual school customer, such as a college or university.

Each school customer would have its own designation, and each student who is attending such a school would have his or her own username and password to obtain access to his or her appropriate courses. The school's courses would be stored by the “home” computer system; each school designation would likely be an abbreviation or an acronym reserved for that individual school's files. For example, if Harvard was the school, then its “home” web server access might use name designators, such as:

harvard.{school's course name}.courseflo.alvacloud.com, or

harvard.{student's username}.courseflo.alvacloud.com.

If the University of Cincinnati was the school, for example, then its “home” web server access might use name designators, such as:

uc.{school's course name}.courseflo.alvacloud.com, or

uc.{student's username}.courseflo.alvacloud.com.

It will be understood that the principles of the technology disclosed herein will apply to situations other than colleges or other types of professional schools. For example, the APP builder and APP editor functions can be used by private businesses, government agencies, individuals such as consultants, and so on. In general, the principles of the technology disclosed herein would be useful in many learning situations, but the individuals who are doing the learning may not be college students.

If a private business wanted to build a training course, or other type of educational course (such as professional education courses, e.g., continuing legal education, professional engineer education, professional accounting education, medical doctor education, etc.) then the term “professor computer” would be applicable to a computer being used by an employee or a consultant of that private business who is engaged in creating or editing the course material. The term “student computer” would still be applicable to a computer being used by a student-type individual; however, that individual might be a professional who is merely learning updated information about his or her profession. Or, the student-type individual might be a government employee being trained in a new area of expertise; one example would be for a person in the military who is being cross-trained in communications equipment, when that person's primary training was in weapons. The term “school computer” would be applicable to a computer that is controlled by the private business, or by some outside service provider with the appropriate computer hardware and operating software, and the APP course (i.e., the APP computer program) could be accessed via a communication link to that “school computer,” which stores the actual course (or controls access to a different computing system that stores the actual course—it could be stored in the cloud, for example).

A government agency could also build some type of training or educational course without use of a typical college or university. Again, the terms “professor computer,” “student computer,” and “school computer” would all be applicable to equipment that is controlled by persons or entities that are not typically thought of as colleges. If, for example, the U.S. Patent and Trademark Office (“PTO”) wanted to create a training program for its patent examiners, the PTO could appoint one of its own employees (or an outside consultant) to use a computer for building the APP course, and that computer would then be considered the “professor computer.” The patent examiners who are to be trained in that APP course would each be assigned a computer to use for viewing the course contents, and each of those computers would be considered a “student computer.” The term “school computer” would be applicable to a computer that is controlled by the PTO, or by some outside service provider (contracted by the PTO) with the appropriate computer hardware and operating software, and the APP course could then be accessed via a communication link to that “school computer.” The “school computer” either stores the actual course, or it controls access to a different computing system that stores the actual course—again, it could be stored in the cloud, for example. A separate computer system controlled by a private company service provider (such as an LMS, or a “home” computer system) might be the computing system that determines exactly where each course is stored, including courses stored in the cloud, and that separate computer system will work hand in hand with the school computer. From that standpoint, the separate computer system is essentially part of the school computer when it comes to obtaining access to courses that have been built.

In conclusion, the terms “professor computer,” “student computer,” “school computer,” “professor,” and “student” as used herein, and in the claims, are applicable to all the situations discussed above, and to other similar learning or training situations that were not specifically addressed above. The term “first computer” could have been used instead the term “professor computer” herein, including in the claims—but that would have made this description much more difficult to understand. Similarly, the term “second computer” could have been used instead the term “student computer” herein, including in the claims; and the term “third computer” could have been used instead the term “school computer” herein, including in the claims. Therefore, the meaning of these terms, “professor computer,” “student computer,” and “school computer” in the claims should be interpreted as “first,” “second,” and “third” computers, with regard to who is using and providing those computers for the overall claimed system. The functions of such computers are described in the claims.

It will be understood that there are many options available with the technology disclosed herein. For example, when the content is made available to students for a particular course and lecture, that content could be derived directly from the school's dedicated server 22 as discussed above, or that content could be made available through one of the private company service providers 30. For example, such content could be available from the iTunes Store, or from the GooglePlay Store; and other types of computer software stores may in time have such capabilities.

It will be understood that the logical operations described in relation to the flow charts of FIGS. 2-6 and 9-10 can be implemented using sequential logic (such as by using microprocessor technology), or using a logic state machine, or perhaps by discrete logic; it even could be implemented using parallel processors. One embodiment may use a powerful minicomputer or a mainframe computer, particularly for the school computer system, or for the Internet servers and/or the cell phone nodes. Another embodiment may use a microprocessor or microcontroller (e.g., a microprocessor on a tablet computer) to execute software instructions that are stored in memory cells within an ASIC. In fact, the entire microprocessor, along with RAM and executable ROM, may be contained within a single ASIC, in one mode of the technology disclosed herein. Of course, other types of circuitry could be used to implement these logical operations depicted in the drawings without departing from the principles of the technology disclosed herein. In any event, some type of processing circuit will be provided, whether it is based on a microprocessor, a logic state machine, by using discrete logic elements to accomplish these tasks, or perhaps by a type of computation device not yet invented; moreover, some type of memory circuit will be provided, whether it is based on typical RAM chips, EEROM chips (including Flash memory), by using discrete logic elements to store data and other operating information, or perhaps by a type of memory device not yet invented.

It will also be understood that the precise logical operations depicted in the flow charts of FIGS. 2-6 and 9-10, and discussed above, could be somewhat modified to perform similar, although not exact, functions without departing from the principles of the technology disclosed herein. The exact nature of some of the decision steps and other commands in these flow charts are directed toward existing and future models of high level computing systems (those involving the school computer, for example), and toward existing and future models of wireless portable computers (those which run an APP computer program, for example) and certainly similar, but somewhat different, steps would be taken for use with other models of tablet-style computers in many instances, with the overall inventive results being the same.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

What is claimed is:

1. A computer system, comprising:
(a) at least one professor computer having a first processing circuit, a first memory circuit, a first communication circuit, a first display, and a first input device;
(b) at least one student computer having a second processing circuit, a second memory circuit, a second communication circuit, a second display, and a second input device;
(c) a school computer having a third processing circuit, a third memory circuit, and a third communication circuit; and
(d) at least one web server that is in communication, as needed, with said first communication circuit, said second communication circuit, and said third communication circuit;
(e) wherein said first processing circuit and said third processing circuit, working together as needed, are programmed with computer code to perform functions of building an application (APP) by:
(i) receiving content data and generating hypertext markup language (HTML) components;
(ii) generating computer language code components;
(iii) using said computer language code components and said HTML components, generating a package in at least one output protocol type, including at least one of:
(A) a Java protocol package, and
(B) an IOS protocol package;
(iv) making said package available for downloading, by use of said at least one web server; and
(f) wherein said second processing circuit is programmed with computer code to perform functions of:
(i) downloading said package using said second communication circuit, and storing said package as an APP in said second memory circuit; and
(ii) running said APP, as desired by a student, including the functions of:
(A) displaying education course content on said second display, under control of said student, thereby allowing said student to study; and
(B) tracking said student's studying progress when said student studies using said APP, whether said at least one student computer is currently on-line with said at least one web server or is currently off-line, and storing said studying progress in said second memory circuit.

2. The computer system of claim 1, wherein said second processing circuit is further programmed with computer code to perform functions of running said APP, including the functions of:
(a) using said second display, allowing said student to take a test and to input test answers, using said second input device; and
(b) communicating said test answers to said school computer, under the control of said student, using said second and third communication circuits when said student computer is on-line to said at least one web server.

3. The computer system of claim 1, wherein said second processing circuit is further programmed with computer code to perform functions of running said APP, including the function of:
(a) communicating said studying progress to said school computer, under the control of said second processing circuit, using said second and third communication circuits when said student computer is on-line to said at least one web server.

4. The computer system of claim 1, further comprising a biometric sensor; then validating said student's identification while the student is studying.

5. The computer system of claim 2, further comprising a biometric sensor; then validating said student's identification while the student is taking said test.

6. The computer system of claim 1, wherein said first processing circuit and said third processing circuit, working together as needed, are programmed with computer code to perform functions of making changes to said APP by:
(a) editing said first content data, thereby creating a second set of content data;
(b) generating a second set of computer language code components;
(c) using said second set of computer language code components and said second set of content data, generating a second package in at least one output protocol type; and
(d) making said second package available for downloading, by use of said at least one web server.

7. A computer system, comprising:
(a) at least one professor computer having a first processing circuit, a first memory circuit, a first communication circuit, a first display, and a first input device;
(b) at least one student computer having a second processing circuit, a second memory circuit, a second communication circuit, a second display, and a second input device;
(c) a school computer having a third processing circuit, a third memory circuit, and a third communication circuit; and
(d) at least one web server that is in communication, as needed, with said first communication circuit, said second communication circuit, and said third communication circuit;
(e) wherein said first processing circuit and said third processing circuit, working together as needed, are programmed with computer code to perform functions of building an application (APP) by:
(i) receiving content data and generating hypertext markup language (HTML) components;
(ii) generating computer language code components;
(iii) using said computer language code components and said HTML components, generating a package in at least one output protocol type, including at least one of:
(A) a Java protocol package, and
(B) an IOS protocol package;
(iv) making said package available for downloading, by use of said at least one web server; and
(f) wherein said second processing circuit is programmed with computer code to perform functions of:
(i) downloading said package using said second communication circuit, and storing said package as an APP in said second memory circuit;
(ii) running said APP, as desired by a student, including the functions of:
(A) displaying education course content on said second display, under control of said student, thereby allowing said student to study;
(B) tracking said student's studying progress when said student studies using said APP, and storing said studying progress in said second memory circuit; and
(C) communicating said studying progress to said school computer, under the control of said second processing circuit, using said second and third communication circuits when said student computer is on-line to said at least one web server.

8. The computer system of claim 7, wherein said function of communicating said studying progress to said school computer is not under the control of said student, even though it remains under the control of said second processing circuit, according to said APP.

9. The computer system of claim 8, wherein said function of communicating said studying progress to said school computer occurs without said student being aware.

10. The computer system of claim 7, further comprising a biometric sensor; then validating said student's identification while the student is studying.

11. The computer system of claim 7, wherein said second processing circuit is further programmed with computer code to perform functions of running said APP, including the functions of:
(a) using said second display, allowing said student to take a test and to input test answers, using said second input device; and
(b) communicating said test answers to said school computer, under the control of said student, using said second and third communication circuits when said student computer is on-line to said at least one web server.

12. The computer system of claim 11, further comprising a biometric sensor; then validating said student's identification while the student is taking said test.

13. The computer system of claim 7, wherein said first processing circuit and said third processing circuit, working together as needed, are programmed with computer code to perform functions of making changes to said APP by:
(a) editing said first content data, thereby creating a second set of content data;
(b) generating a second set of computer language code components;
(c) using said second set of computer language code components and said second set of content data, generating a second package in at least one output protocol type; and
(d) making said second package available for downloading, by use of said at least one web server.

14. The computer system of claim 7, wherein both said functions of:
(a) running said APP for displaying education course content on said second display, and
(b) tracking said student's studying progress when said student studies using said APP,
occur whether said student computer is on-line or off-line.

15. A computer system, comprising:
(a) at least one professor computer having a first processing circuit, a first memory circuit, a first communication circuit, a first display, and a first input device;
(b) at least one student computer having a second processing circuit, a second memory circuit, a second communication circuit, a second display, and a second input device;
(c) a school computer having a third processing circuit, a third memory circuit, and a third communication circuit; and
(d) at least one web server that is in communication, as needed, with said first communication circuit, said second communication circuit, and said third communication circuit;
(e) wherein said first processing circuit and said third processing circuit, working together as needed, are programmed with computer code to perform functions of building an application (APP) by:
(i) receiving content data and generating hypertext markup language (HTML) components;
(ii) generating computer language code components;
(iii) using said computer language code components and said HTML components, generating a package in at least one output protocol type;
(iv) making said package available for downloading, by use of said at least one web server;
(f) wherein said first processing circuit is programmed with computer code to perform functions of:
(i) allowing a professor to initiate a synchronous lecture, using said first communication circuit, said first display, and said first input device, as needed;
(ii) broadcasting said synchronous lecture, using said at least one web server;
(iii) displaying images of at least one student who is virtually attending said synchronous lecture from at least one remote location;
(iv) during said synchronous lecture in real time, selecting a first student of said at least one student for answering a question posed by said professor, in near real time;
(v) broadcasting an answer by said first student; and
(g) wherein said second processing circuit is programmed with computer code to perform functions of:
(i) downloading said package using said second communication circuit, and storing said package as an APP in said second memory circuit;
(ii) running said APP as a synchronous lecture, at a predetermined time as determined by said third processing circuit:
(iii) using said second display and said second communication circuit, allowing said at least one student to view said synchronous lecture in real time; and
(iv) using said second input device and said second communication circuit, allowing said first student to respond in real time with said answer to said question posed by said professor.

16. The computer system of claim 15, wherein said first processing circuit is further programmed with computer code to perform functions of displaying an enlarged image of said first student after being selected by said professor.

17. The computer system of claim 15, wherein:
(a) said first input device comprises a first microphone;
(b) said second input device comprises a second microphone;
(c) said first processing circuit is further programmed with computer code to perform functions of generating first audio information and outputting second audio information at said at least one professor computer; and
(d) said second processing circuit is further programmed with computer code to perform functions of generating said second audio information and outputting said first audio information at said at least one student computer.

18. The computer system of claim 17, wherein:
(a) said first input device further comprises a first imaging camera;
(b) said second input device further comprises a second imaging camera;
(c) said first processing circuit is further programmed with computer code to perform functions of generating first image information and outputting second image information at said at least one professor computer; and
(d) said second processing circuit is further programmed with computer code to perform functions of generating said second image information and outputting said first image information at said at least one student computer.

19. The computer system of claim 15, wherein: said first processing circuit is further programmed with computer code to perform a function of displaying thumbnail images of all of said at least one student at said first display.

20. The computer system of claim 19, wherein, said first processing circuit is further programmed with computer code to perform at least one of the following functions:
(a) storing in advance said thumbnail images of all of said at least one student in said first memory circuit, and displaying said thumbnail images as static displays; and
(b) displaying said thumbnail images of all of said at least one student at said first display as live images that are received using said first communication circuit.

21. A computer system, comprising:
(a) a professor computer having a first processing circuit, a first memory circuit, a first communication circuit, a first display, and a first input device;
(b) at least one student computer having a second processing circuit, a second memory circuit, a second communication circuit, a second display, and a second input device;
(c) a school computer having a third processing circuit, a third memory circuit, and a third communication circuit; and
(d) at least one web server that is in communication, as needed, with said first communication circuit, said second communication circuit, and said third communication circuit;
(e) wherein said first processing circuit and said third processing circuit, working together as needed, are programmed with computer code to perform functions of modifying a first multi-media course by:
(i) using at least one of said professor computer and said school computer, accessing said first multi-media course that is stored at a predetermined virtual location;
(ii) using at least one of said professor computer and said school computer, viewing said first multi-media course as a plurality of individual files that can each be modified by native editing software;
(iii) using at least one of said professor computer and said school computer, editing at least one of said plurality of individual files, thereby creating a second at least one individual file;
(iv) storing said second at least one individual file at a predetermined virtual location that will be accessible by at least one of said professor computer and said school computer;
(v) inserting said second at least one individual file into said first multi-media course, thereby integrating said second at least one individual file into a second multi-media course;
(f) wherein said first processing circuit and said third processing circuit, working together as needed, are programmed with computer code to perform functions of re-purposing said second multi-media course automatically, by:
(i) using at least one of said professor and school computers, uploading said second at least one individual file to at least one of said school computer and a home web server, thereby updating said first multi-media course into said second multi-media course at said at least one of said school computer and said home web server;
(ii) using at least one of said professor and school computers, and using said second multi-media course, generating at least one of a Java package and an IOS package;
(iii) using at least one of said professor computer, said school computer, and said home web server, uploading said at least one of said Java package and said IOS package to at least one corresponding APP store; and
(g) wherein said second processing circuit is programmed with computer code to perform functions of allowing said at least one student computer, for use by at least one authorized student user, to access at least one of: (i) said second multi-media course at said school computer; (ii) said second multi-media course at said home web server; (iii) a new Android APP based on said Java package at an Android APP store; and (iv) a new Apple APP based on said IOS package at an Apple APP store.

22. The computer system of claim 21, wherein:
(a) said home web server comprises a “home” computer that includes a fourth processing circuit, a fourth memory circuit, and a fourth communication circuit;
(b) said home web server is in communication, as needed, with said first communication circuit, said second communication circuit, and said third communication circuit; and
(c) said fourth processing circuit is programmed with computer code to perform functions of acting as at least one of:
(i) a learning management system (LMS); and
(ii) a course builder system.

23. The computer system of claim 21, wherein at part (e)(ii), said first processing circuit and said third processing circuit, working together as needed, are further programmed with computer code to perform a function, if needed, of modifying said first multi-media course by:
re-structuring said first multi-media course into a plurality of individual files that can each be modified by native editing software.

24. The computer system of claim 21, wherein:
at part (f), said first processing circuit and said third processing circuit, working together as needed, are further programmed with computer code to further perform a function of re-purposing said second multi-media course automatically, by:
(a) using at least one of said professor and school computers, and using said second multi-media course, generating a school package;
(b) using at least one of said professor computer, said school computer, and said home web server, uploading said school package to a corresponding college APP store;
and
at part (g), said first processing circuit and said third processing circuit, working together as needed, are further programmed with computer code to further perform a function of allowing said at least one student computer to access a new College APP based on said school package at said corresponding college APP store.

25. The computer system of claim 21, wherein said second processing circuit is programmed with computer code to perform functions of:
(a) running a first APP that was based on a first multi-media course that was previously stored in said second memory circuit, thereby allowing said student user to study under control of said student, by displaying first education course content on said second display, even if the student computer is off-line;
(b) after said second multi-media course has been created to generate at least one of said Java package and said IOS package, then:
(i) allowing said second student computer to login to at least one of said Android APP store and said Apple APP store;
(ii) then downloading said at least one of said Android APP and said Apple APP;
(iii) then storing, in said second memory circuit, said at least one of said Android APP and said Apple APP as a second APP; and
(c) then, running said second APP that was based on said second multi-media course, now stored in said second memory circuit, thereby allowing said student user to study under control of said student, by displaying second education course content on said second display, even if the student computer is off-line.
